(19) United States
(12) Patent Application Publication
(10) Pub. No.: US 2025/0124503 A1
(43) Pub. Date: Apr. 17, 2025

(54) SYSTEMS AND METHODS FOR PROVIDING AN AUTOMATED SERVICING DESKTOP

(71) Applicant: JPMORGAN CHASE BANK, N.A., New York, NY (US)

(72) Inventors: Meghana KANCHARLA, Woodridge, IL (US); Lakshmi POLAVARAPU, Frisco, TX (US)

(21) Appl. No.: 18/488,776

(22) Filed: Oct. 17, 2023

(51) Int. Cl. G06Q 40/03

(52) U.S. Cl. CPC G06Q 40/03

(57) ABSTRACT

Systems and methods for providing an automated servicing desktop are disclosed. A method may include: (1) receiving, by a request processing computer program executed on an electronic device, a loan maintenance request from a source system; (2) extracting, by the request processing computer program, data from the loan maintenance request; (3) verifying, by the request processing computer program, that the loan maintenance request is not a duplicate loan maintenance request; (4) executing, by the request processing computer program, a dynamic lookup for data; (5) applying, by the request processing computer program, rules to the loan maintenance request; (6) generating, by the request processing computer program, a dashboard; (7) determining, by the request processing computer program, that a target service level has not been met; and (8) generating, by the request processing computer program, an alert in response to the target service level not being met.

### BACKGROUND OF THE INVENTION

### 1. Field of the Invention

Embodiments relate to systems and methods for providing an automated servicing desktop.

### 2. Description of the Related Art

Servicing teams receive a considerable amount of requests, and each request includes important information. Processing these requests often involves a large number of manual steps, with little transparency to the requester.

### SUMMARY OF THE INVENTION

Systems and methods for providing an automated servicing desktop are disclosed. According to an embodiment, a method for providing an automated servicing desktop may include: (1) receiving, by a request processing computer program executed on an electronic device, a loan maintenance request from a source system; (2) extracting, by the request processing computer program, data from the loan maintenance request; (3) verifying, by the request processing computer program, that the loan maintenance request is not a duplicate loan maintenance request; (4) executing, by the request processing computer program, a dynamic lookup for data; (5) applying, by the request processing computer program, rules to the loan maintenance request; (6) generating, by the request processing computer program, a dashboard; (7) determining, by the request processing computer program, that a target service level has not been met; and (8) generating, by the request processing computer program, an alert in response to the target service level not being met.

In one embodiment, the source system may include a loan system or a transaction system.

In one embodiment, the loan maintenance request may be received electronically.

In one embodiment, the extracted data may include a transaction identifier, a type of request, a payment amount, a payment currency, and/or an effective date.

In one embodiment, the data may be extracted using a machine learning engine that may be trained with historical requests to identify the data in the request.

In one embodiment, the data may be extracted using a large language model.

In one embodiment, the request processing computer program verifies that the loan maintenance request is not a duplicate based on contextual information extracted from the loan maintenance request.

In one embodiment, the request processing computer program retrieves, from a loan platform for a loan associated with the loan maintenance request, a facility risk rating, a facility availability, and/or transaction history involving the loan.

In one embodiment, the method may also include requesting, by the request processing computer program, additional approvals in response to the facility risk rating being above a threshold.

According to another embodiment, a system may include: a source system, and an electronic device executing a request processing computer program that may be configured to receive a loan maintenance request from the source system, to extract data from the loan maintenance request, to verify that the loan maintenance request is not a duplicate loan maintenance request, to execute a dynamic lookup for data, to apply rules to the loan maintenance request using a rules engine; to generate a dashboard, to determine that a target service level has not been met, and to generate an alert in response to the target service level not being met.

In one embodiment, the source system may include a loan system or a transaction system.

In one embodiment, the loan maintenance request may be received electronically.

In one embodiment, the extracted data may include a transaction identifier, a type of request, a payment amount, a payment currency, and/or an effective date.

In one embodiment, the system may also include a machine learning engine that may be trained with historical requests to identify the data in the request and may be configured to extract the data.

In one embodiment, the data may be extracted using a large language model.

In one embodiment, the request processing computer program may be further configured to verify that the loan maintenance request is not a duplicate based on contextual information extracted from the loan maintenance request.

In one embodiment, the request processing computer program may be further configured to retrieve, from a loan platform for a loan associated with the loan maintenance request, a facility risk rating, a facility availability, and/or transaction history involving the loan.

In one embodiment, the request processing computer program may be further configured to request additional approvals in response to the facility risk rating being above a threshold.

A non-transitory computer readable storage medium, including instructions stored thereon, which when read and executed by one or more computer processors, cause the one or more computer processors to perform steps comprising: receiving a loan maintenance request from a source system that may include a loan system or a transaction system; extracting, using a machine learning engine that may be trained with historical requests to identify data in the request, the data from the loan maintenance request, wherein the extracted data may include a transaction identifier, a type of request, a payment amount, a payment currency, and/or an effective date; verifying that the loan maintenance request is not a duplicate loan maintenance request based on contextual information extracted from the loan maintenance request; executing a dynamic lookup for data; applying rules to the loan maintenance request; generating a dashboard; determining that a target service level has not been met; and generating an alert in response to the target service level not being met.

In one embodiment, the non-transitory computer readable storage medium may also include instructions stored thereon, which when read and executed by one or more computer processors, cause the one or more computer processors to perform steps comprising: retrieving, from a loan platform for a loan associated with the loan maintenance request, a facility risk rating, a facility availability, and/or transaction history involving the loan; and requesting additional approvals in response to the facility risk rating being above a threshold.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for providing an automated servicing desktop according to an embodiment;

FIGS. 2A and 2B illustrate a method for providing an automated servicing desktop according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for providing an automated servicing desktop.

Embodiments may strengthen and standardize the global operating model agnostic to loan systems and lines of business. Embodiments may receive daily transactional requests from, for example, clients, bankers, market, etc., ranging from advance requests, payments, quotes, reprices, etc. via various channels of ingestion. Embodiments may use enhanced Optical Character Recognition (OCR) capabilities to read the client requests. Multi system integrations, coupled with intelligent business rules and a streamlined user interface may reduce the end-to-end processing time and may minimize manual intervention. This reduces operational risk via tightened controls and increased transparency.

Transaction requests may be received, for example, by email, facsimile, virtual data rooms, client invites, etc. Embodiments may use OCR capability for extraction of data from the requests and intelligent identification of duplicate requests.

Embodiments may aggregate information from multiple data source systems, and may provide a platform that is agnostic to the source system. Embodiments may further validate client requests using a complex rule engine.

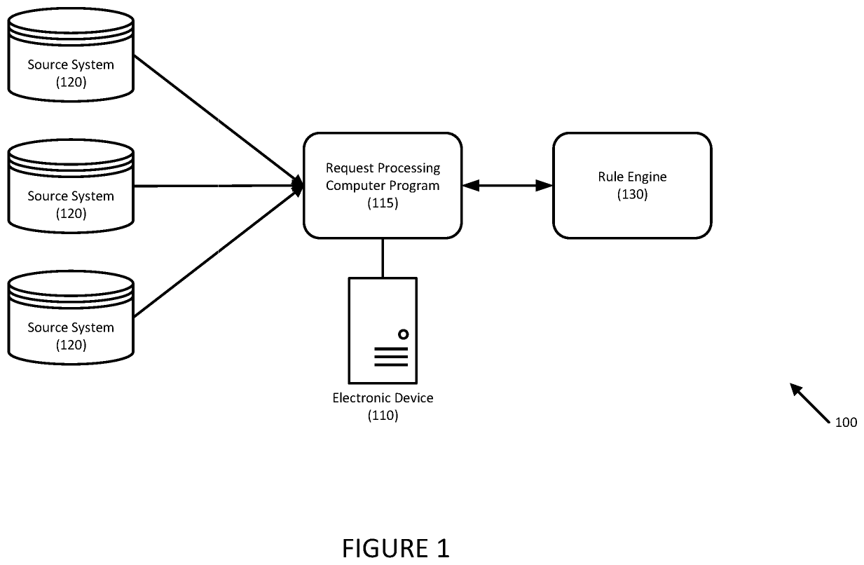

Referring to FIG. 1, a system for providing an automated servicing desktop is disclosed according to an embodiment. System 100 may include electronic device 110 that may execute request processing computer program 115. Electronic device 110 may include any suitable electronic device, including servers (e.g., physical and/or cloud-based), computers (e.g., workstations, desktops, laptops, tablets, etc.), smart devices (e.g., smart phones, smart watches, etc.), IoT appliances, etc. Request processing computer program 115 may receive requests from one or more source system 120, such as borrowing systems, loan systems, etc. Request processing computer program 115 may use rules engine 130 to apply rules to incoming requests to validate the request.

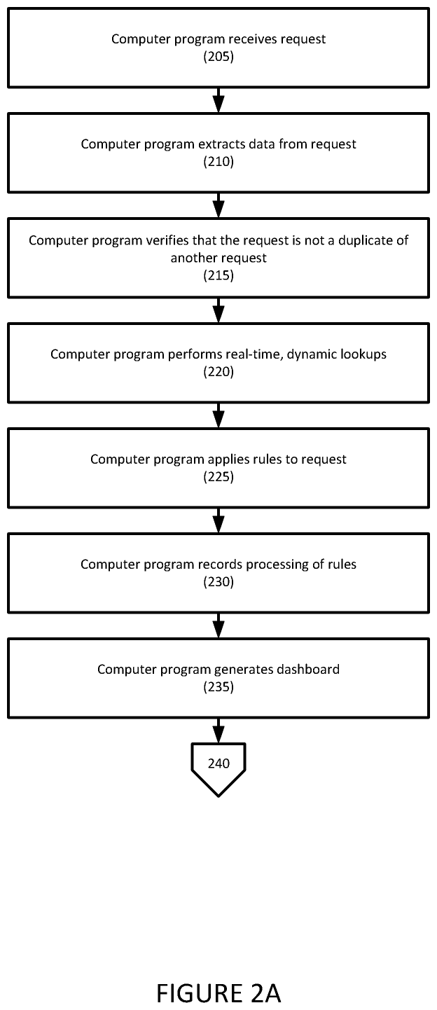

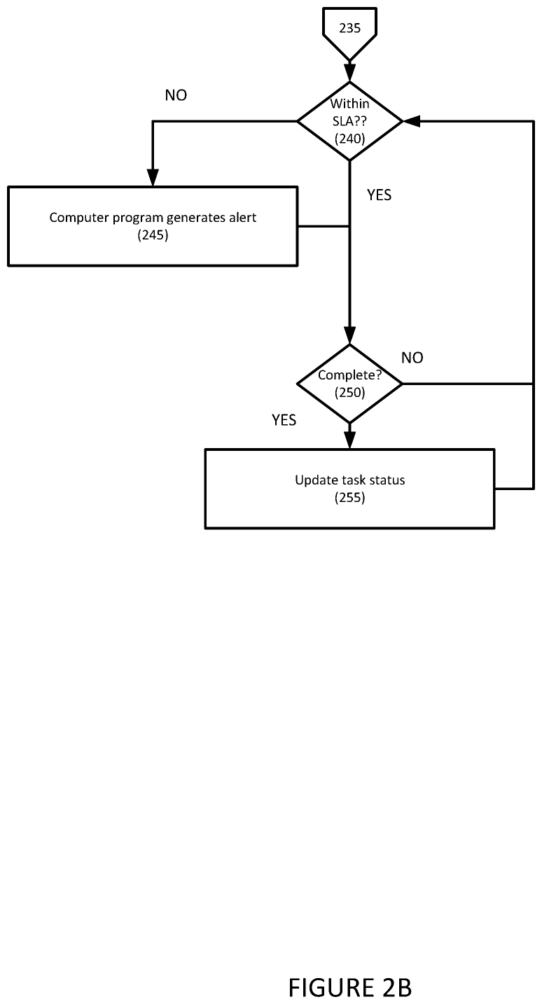

Referring to FIGS. 2A and 2B, a method for providing an automated servicing desktop is disclosed according to an embodiment.

In step 205, a computer program, such as a request processing computer program, executed on an electronic device may receive a request from a source system. For example, the source system may be a loan system, a transaction system, etc. The request may be received, for example, by paper, by phone, over the Internet (e.g., email, application, web, etc.), by facsimile, etc. In one embodiment, the request may be received from a client directly, may be received at a shared mail box, a customer support call, systems that may autogenerate the request from a loan platform, etc.

In one embodiment, the request may be for any kind of loan maintenance request, such as transactional or non transaction, advance, payment, repricing, new loan draw, facility fee, payoff quote, loan status report, address change, auto pay set up, etc. The request may identify a request type, an effective date, a payment amount, a transaction (e.g., loan) reference, and a currency.

In step 210, the computer program may extract data from the request. In one embodiment, the computer program may use optical character recognition to extract the transaction identifier, the type of request, the payment amount, the payment currency, the effective date, etc. from the request.

In one embodiment, the request may be templated or semi-structured. In one embodiment, a large language model may be used to extract contextual information from the request. In another embodiment, a machine learning engine may be trained to extract the transaction identifier, the type of request, the payment amount, the payment currency, the effective date, etc. from the request.

In step 215, the computer program may verify that the request is not a duplicate of another request (e.g., the client has not submitted the same request via different channels). For example, the computer program may extract contextual information from the request and may use the contextual information to determine a similarity confidence between different requests. If the transactional attributes for the request match those of a previous request, the request is deemed to be a duplicate, and the request may be deleted or otherwise not processed.

In step 220, the computer program may perform real-time, dynamic lookups using the extracted data. For example, the computer program may access a loan platform that hosts the loan, the deal, etc. The computer program may retrieve facility risk ratings, facility availability, facility maturity date, risk officers, treasury services, previous transaction history and requests (e.g., 60 days), etc. In one embodiment, if the facility is above a threshold, indicating a high risk, additional approvals may be required before processing cash out.

In one embodiment, a treasury interface may be triggered when a non-match fund loan gets turned into a match funded loan.

In one embodiment, the data may be returned in a consolidated manner. For example, embodiments may make parallel REST API calls to multiple source system, organizes the data in a hierarchical manner. Deal, Facility, and Loan level may be provided in panels with the source system as a post script to the user interface fields, and an accuracy percentage along with link to context from which data is extracted may be provided for the extracted data.

In step 225, the computer program may apply rules to the request using a complex rule engine. In one embodiment, the rules may validate that the request is a proper request. The rules may vary based on, for example, the request type, the loan type, pricing options, regional regulation(s), holiday calendars, credit agreements, etc. For example, the rules may check for the facility risk rating. If the facility risk rating is above a threshold, indicating a high risk a checklist is enforced and proof of approvals needs to be attached, if the requested repricing option is not set up, it displays the message, checks if effective date or repricing date is a holiday, check if the client loan and loan system are in sync for balances, date and accrual cycles, etc.

In step 230, the computer program may record and process the results of the application of the rules. Application of the rules may result in a pass in which no user interaction is required, a hard stop, where the processor collaborates with client to patch the system that eventually causes the rules to pass, soft warnings that prompt the user that there is a minor mismatch within a threshold, etc.

In step 235, the computer program may generate a dashboard and may automatically assign tasks associated with the requests. For example, the computer program may monitor the currently logged in services into the system and, the number of requests in each of their queues, effective processing dates requested to distribute the new incoming request Embodiments may also track the status of the assigned tasks, and may track the processing of the request relative to a service level agreement (SLA).

Once assigned, the services may execute the assigned tasks. The case status may reflect the progress made on the request including completion which is end state.

In step 240, the computer program may compare the processing of the task to the SLA. For example, the computer program may determine if the processing of the task by the systems is taking longer than the time specified in the SLA. If the processing breaches a SLA, in step 245, the computer program may generate an alert.

In one embodiment, the SLA may be determined when the request type is identified. For example, cash out has a 30 min SLA, cash in has an end of day SLA, etc. The SLA may be breached when user intervention is required and is delayed. Along with the SLA breach, users may be prompted to review the breach reason that needs to be reviewed by a manager.

In step 250, the computer program may determine whether the task is complete. For example, the service may report that the task has been completed. If it is, in step 255, update the status of the task and may continue with the next task until all tasks are complete.

In one embodiment, the next task may be automatically opened upon completion of the current task.

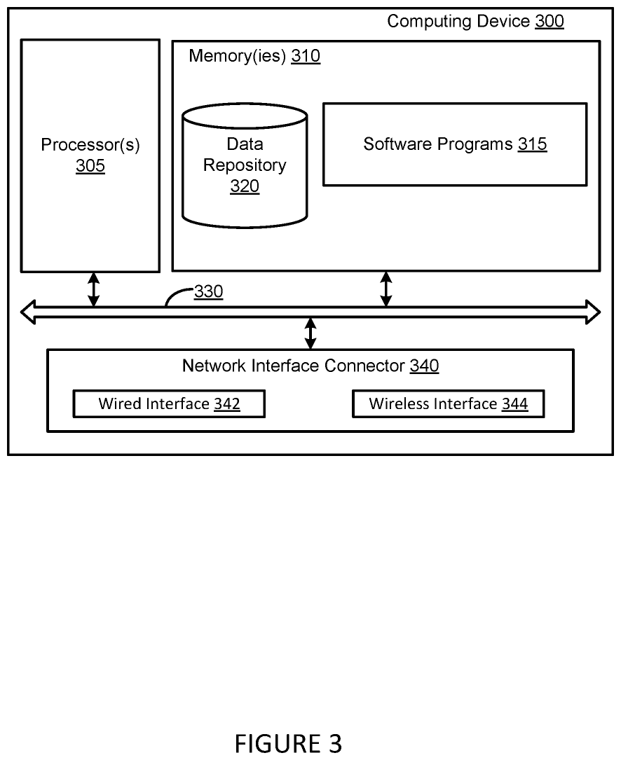

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing an automated servicing desktop, comprising:
receiving, by a request processing computer program executed on an electronic device, a loan maintenance request from a source system;
extracting, by the request processing computer program, data from the loan maintenance request;
verifying, by the request processing computer program, that the loan maintenance request is not a duplicate loan maintenance request;
executing, by the request processing computer program, a dynamic lookup for data;
applying, by the request processing computer program, rules to the loan maintenance request;
generating, by the request processing computer program, a dashboard;
determining, by the request processing computer program, that a target service level has not been met; and
generating, by the request processing computer program, an alert in response to the target service level not being met.

2. The method of claim 1, wherein the source system comprises a loan system or a transaction system.

3. The method of claim 1, wherein the loan maintenance request is received electronically.

4. The method of claim 1, wherein the extracted data comprises a transaction identifier, a type of request, a payment amount, a payment currency, and/or an effective date.

5. The method of claim 1, wherein the data is extracted using a machine learning engine that is trained with historical requests to identify the data in the request.

6. The method of claim 1, wherein the data is extracted using a large language model.

7. The method of claim 1, wherein the request processing computer program verifies that the loan maintenance request is not a duplicate based on contextual information extracted from the loan maintenance request.

8. The method of claim 1, wherein the request processing computer program retrieves, from a loan platform for a loan associated with the loan maintenance request, a facility risk rating, a facility availability, and/or transaction history involving the loan.

9. The method of claim 8, further comprising:
requesting, by the request processing computer program, additional approvals in response to the facility risk rating being above a threshold.

10. A system, comprising:
a source system; and
an electronic device executing a request processing computer program that is configured to receive a loan maintenance request from the source system, to extract data from the loan maintenance request, to verify that the loan maintenance request is not a duplicate loan maintenance request, to execute a dynamic lookup for data, to apply rules to the loan maintenance request using a rules engine; to generate a dashboard, to determine that a target service level has not been met, and to generate an alert in response to the target service level not being met.

11. The system of claim 10, wherein the source system comprises a loan system or a transaction system.

12. The system of claim 10, wherein the loan maintenance request is received electronically.

13. The system of claim 10, wherein the extracted data comprises a transaction identifier, a type of request, a payment amount, a payment currency, and/or an effective date.

14. The system of claim 10, further comprising a machine learning engine that is trained with historical requests to identify the data in the request and is configured to extract the data.

15. The system of claim 10, wherein the data is extracted using a large language model.

16. The system of claim 10, wherein the request processing computer program is further configured to verify that the loan maintenance request is not a duplicate based on contextual information extracted from the loan maintenance request.

17. The system of claim 10, wherein the request processing computer program is further configured to retrieve, from a loan platform for a loan associated with the loan maintenance request, a facility risk rating, a facility availability, and/or transaction history involving the loan.

18. The system of claim 17, wherein the request processing computer program is further configured to request additional approvals in response to the facility risk rating being above a threshold.

19. A non-transitory computer readable storage medium, including instructions stored thereon, which when read and executed by one or more computer processors, cause the one or more computer processors to perform steps comprising:
receiving a loan maintenance request from a source system that comprises a loan system or a transaction system;
extracting, using a machine learning engine that is trained with historical requests to identify data in the request, the data from the loan maintenance request, wherein the extracted data comprises a transaction identifier, a type of request, a payment amount, a payment currency, and/or an effective date;
verifying that the loan maintenance request is not a duplicate loan maintenance request based on contextual information extracted from the loan maintenance request;
executing a dynamic lookup for data;
applying rules to the loan maintenance request;
generating a dashboard;
determining that a target service level has not been met; and
generating an alert in response to the target service level not being met.

20. The non-transitory computer readable storage medium of claim 19, further including instructions stored thereon, which when read and executed by one or more computer processors, cause the one or more computer processors to perform steps comprising:
retrieving, from a loan platform for a loan associated with the loan maintenance request, a facility risk rating, a facility availability, and/or transaction history involving the loan; and
requesting additional approvals in response to the facility risk rating being above a threshold.
